(19) United States
(12) Patent Application Publication
(10) Pub. No.: US 2022/0274877 A1
(43) Pub. Date: Sep. 1, 2022

(54) Thermal Insulating Plaster Mixture

(71) Applicant: FIRST POINT A.S., Hodonin (CZ)

(72) Inventors: Gabriela Chlandová, Borohrádek (CZ); Petr Španiel, Ceské Mezinci (CZ)

(73) Assignee: FIRST POINT A.S., Hodonin (CZ)

(21) Appl. No.: 17/625,089

(22) PCT Filed: May 26, 2020
(86) PCT No.: PCT/CZ2020/000021

§ 371 Date: Jan. 5, 2022

(30) Foreign Application Priority Data
Jul. 5, 2019 (CZ) PV 2019-448

(51) Int. Cl. C04B 28/06; C04B 14/24; C04B 24/08; C04B 24/12; C04B 24/26

(52) U.S. Cl. CPC C04B 28/06; C04B 14/24; C04B 24/08; C04B 24/122; C04B 24/2641; C04B 2103/40

(57) ABSTRACT

A mixture for a thermal insulating plaster, especially a mixture for a thermal insulating plaster that contains aqueous solution of silicate, which contains 78 to 90 volume percent of hollow glass microspheres, 5 to 17 volume percent of aqueous solution of potassium silicate, 0.1 volume percent of water-glass-binder stabilizer, 1.5 to 5 volume percent of styrene-acrylate dispersion, 0.4 to 3 volume percent of aqueous colloidal solution of silver, 0.2 to 2.4 volume percent of tensides as an aerating agent, and 0.5 to 7 volume percent of water.

### TECHNICAL FIELD

The invention relates to a mixture for a thermal insulating plaster, especially to a mixture for a thermal insulating plaster that contains aqueous solution of silicate.

### STATE OF THE ART

It is known from the existing state of the art that thermal insulating materials such as polystyrene, polyurethane, mineral wool, expanded perlite and others are commonly used in order to reduce thermal transmittance through walls and ceilings. Their disadvantage is the thickness of their layers which considerably thickens the masonry itself by up to tens of centimetres. In historic or architecturally valuable buildings with distinctive reliefs of interior plasterwork or facade coating, the use of the aforementioned materials could result in devaluation of such buildings. In addition to the above, this type of insulating materials cannot be used if a building has already been completed including its facade. If these materials are used in interiors, the inner space is made considerably smaller. Another disadvantage of these materials is their complicated application.

The state of the art also knows thermal insulating paints looking like common interior plasters. These paints are usually applied in 1-2 mm thick layers. Besides organic polyacrylate or polyvinylacetate binders, these paints contain mainly hollow glass microspheres and aerogel to fill the spaces between the microspheres. Their main disadvantage is the fact that the surface of the microspheres shows very little resistance to mechanical wear and tear, the microspheres are not thermally stable, water resistant or permanently fungicidal.

Utility Design CZ 31596 describes a mixture for a thin-layered thermo reflective finish which contains 25 to 30 weight percent of porous perlite spheres of 0.35 mm, 10 weigh percent of ceramic spheres of 0.23 mm, 50 to 55 weight percent of potash water glass, 1 to 5 weight percent of water, 0.5 weight percent of binder stabilizer—hydrophilic alkoxyle alkyl ammonia salts, 2 to 7 weight percent of styrene-acrylate dispersion, 0.5 weight percent of tensides as an aerating agent, 1 weight percent of silicone emulsion as a hydrophobizing ingredient and 1 weight percent of sodium hexametaphosphate as a dispersing agent. An advantage of this mixture is absorptivity of the perlite spheres.

Another Utility Design CZ 31269 describes a mixture for a thin-layered thermo reflexive finish which contains 40 to 45 weight percent of porous glass spheres of 0.25 to 0.5 mm, 40 to 45 weight percent of potash water glass, 5 to 10 weight percent of water, 0.5 weight percent of binder stabilizer—hydrophilic alkoxyle alkyl ammonia salts, 3 to 7 weight percent of styrene-acrylate dispersion, 0.5 weight percent of tensides as an aerating agent, 1 weight percent of silicone emulsion as a hydrophobizing ingredient, 1 weight percent of sodium hexametaphosphate(8-) as a dispersing agent. This Utility Design also describes a mixture for a thin-layered thermo reflexive finish which contains 23 to 29 weight percent of hollow glass spheres of 0.089 mm, 35 to 40 weight percent of potash water glass, 23 to 29 percent of water, 0.5 weight percent of binder stabilizer—hydrophilic alkoxyle alkyl ammonia salts, 5 to 9 weight percent of styrene-acrylate dispersion, 0.5 weight percent of tensides as an aerating agent, 1 weight percent of silicone emulsion as a hydrophobizing ingredient, 1 weight percent of sodium hexametaphosphate(8-) as a dispersing agent. Disadvantages of both these mixtures is a relative big amount of water glass which decreases their insulating capabilities.

It is obvious from the aforementioned the state of the art that the commonly known plaster mixtures have a great number of disadvantages and that the main disadvantage appears to be their lower insulating power.

The goal of our invention is to formulate a mixture for making a simple, cheap, non-absorptive thermal insulating plaster having a considerably higher insulating power than those plaster mixtures that are known so far.

### Principle of the Invention

The aforementioned disadvantages are, to a large extent, eliminated and the goals of the invention accomplished by a thermal insulating plaster mixture, especially a mixture to make a thermal insulation plaster containing water silicate solution according to the invention the nature of which consists in the fact that the mixture contains 78 to 90 volume percent of hollow glass microspheres, 5 to 17 volume percent of aqueous solution of potassium silicate, 0.1 volume percent of water-glass-binder stabilizer, 1.5 to 5 volume percent of styrene-acrylate dispersion, 0.4 to 3 volume percent of aqueous colloidal solution of silver, 0.2 to 2.4 volume percent of tensides as an aerating agent, and 0.5 to 7 volume percent of water. An advantage of this mixture is its considerably higher insulating power if compared with the mixtures known from the state of the art known so far. Its water content improves its properties when the mixture is being applied. The admixture of calcium stearate and sodium oleate improves aeration of the mixture and increases its general porosity. At the same time, open porosity is decreased and penetration of water into capillary tubes is prevented. Thus, the absorption coefficient is reduced to no more than one tenth of the value shown in common plasters. No capillary elevation of moisture takes place in the material as the hydrophobization is effective in its whole volume. It should be stressed that the admixture of the stearate and oleate does not change the diffusion properties of the material.

As another variant, the aforementioned disadvantages are, to a large extent, eliminated and the goals of the invention accomplished by a thermal insulating plaster mixture, especially by a mixture for a thermal insulation plaster containing aqueous silicate solution according to the invention whose nature consists in the fact that the mixture contains 75 to 90 volume percent of porous glass spheres, 1 to 4 volume percent of hollow glass microspheres, 4 to 14 volume percent of aqueous solution of potassium silicate, 1 to 6 percent of aqueous solution of sodium silicate, 0.1 volume percent of water-glass-binder stabilizer, 0.3 to 3 volume percent of styrene-acrylate dispersion, 0.4 to 3 volume percent of aqueous colloidal solution of silver, 0.2 to 2.4 volume percent of tensides as an aerating agent, 0.5 to 7 volume percent of water, and 0.1 to 1.5 volume percent of admixture of calcium stearate and sodium oleate in the ratio of 1:2. Besides considerable higher insulating power if compared to the state of the art known so far, a great advantage of this mixture is the combination of two kinds of water glass which brings optimum properties as for its adhesion, binding power and spreading property. The compactness of the mixture with porous spheres is considerably increased by the fact that the mixture also contains hollow microspheres. These microspheres fill the spaces between the porous spheres. This makes the whole material consistent and the binder does not settle down. The microspheres also improve adhesion and binding power of the mixture in a considerable way. Another advantage is also the fact that the binder for the porous glass spheres also contains (besides potash water glass) soda water glass besides potash water glass. This mixture shows, in the claimed ratio, excellent adhesion to all kinds of surfaces and makes its application on background material easier. In addition to the above, the fact that the mixture contains the styrene-acrylate dispersion is also very advantageous as this dispersion increases its elasticity, binding power and adhesion to the surface on the principle of creating weak interactions between organic and acrylate polymers. For better dispersion of the light filler in the binder and for slowing down its gravitational sedimentation, tensides are further added in the mixture. The water content increases properties of the mixture when being applied. The admixture of calcium stearate and sodium oleate improves aeration of the mixture and increases its general porosity. At the same time, open porosity decreases and penetration of water into capillary tubes is prevented. Thus, the absorption coefficient is reduced to no more than one tenth of the value shown in common plasters. No capillary elevation of moisture takes place in the material as the hydrophobization is effective in its whole volume. It should be stressed that the admixture of the stearate and oleate does not change the diffusion properties of the material.

The thermal insulating plaster mixture shows a considerable improvement of biocidal properties if it further contains 0.4 to 3 volume percent of aqueous colloidal solution of silver. In the most advantageous version, the concentration of the aqueous colloidal solution of silver is 0.01 percent. The size of the colloidal particles of silver is advantageously ranging from 1 to 15 nm.

It is advantageous if the stabilizer of the water glass binder is composed of hydrophilic alkoxyle alkyl ammonia salts.

It is extremely advantageous if the size of the porous glass spheres ranges from 0.25 to 2 mm. Further, for a very coarse mixture, the bulk density of the spheres ranges from 190 to 250 g/litre and their apparent density is within the range from 0.31 to 0.42 g/cm³. For a coarse mixture, their bulk density ranges from 210 to 290 g/litre and the apparent density ranges from 0.38 to 0.51 g/cm³. For a fine mixture, the bulk density of the spheres ranges from 255 to 345 g/litre and the apparent density from 0.46 to 0.62 g/cm³. On these parameters, the thickness of the walls of the spheres, which is very important, is based. The wall must not be too thin so that the alkaline binder cannot bite into them and it must not be too thick so that the sufficient insulating power of the spheres can be ensured. It is also advantageous if the size of the hollow glass microspheres is within the range from 0.05 to 0.08 mm. The optimum compressive strength of the hollow glass microspheres is 3.445 MPa, and their apparent density 0.18 to 0.22 g/cm³. These parameters are tied in with the thickness of the walls. Too thin walls can lead to breaking the spheres and their partial corrosion when the plaster is being mixed, too thick walls, on the other hand, decrease their thermal insulating power.

It is also very advantageous if the molar ratio between silicon dioxide and potassium oxide in the aqueous solution of potassium silicate ranges from 3.8 to 4.1 and if the density of the aqueous solution ranges from 1230 to 1250 kg/m³. The glass created from this solution has several advantages: Excellent fungicidal properties, high incombustibility, heat resistance, sufficient hardness and abrasion resistance, vapour permeability and water resistance after getting dry.

Further, it is very advantageous if the molar ratio between silicon dioxide and sodium oxide in the aqueous solution of sodium silicate ranges from 3.2 to 3.4 and if the density of the aqueous solution is within the range from 1370 to 1400 kg/m³. An advantage is the fact that this composition has an influence on rheological properties of the water glass as a polymeric mixture, on electrical properties, on compressibility and adhesive power like with an electrolyte, on hardness, strength etc.

The main advantage of the thermal insulating plaster mixture according to this invention is the fact that its fire properties are considerably improved. A great advantage is its better adhesion to the masonry, higher surface hardness, abrasion resistance and higher granularity of the filling agent which makes it look like a common stucco plaster. Another advantage is very easy application either by spraying or by means of a spreader. Individual coatings can easily be mutually connected and repaired. The mixture can even resist a direct flame of 1,200° C. from a gas burner while the underlying material remains intact. The material has high porosity and also, owing to the hydrophobizing treatment, low absorptivity. The material performs like a sanitation plaster. A great advantage is also the fact that the mixture can be used for thin-walled fire-protection plasters to be applied on the oriented strand boards (OSB) to be used in wooden structures. According to the respective test results, the plaster applied on the OSB resists a direct flame of 1,500 to 1,800° C. from a gas burner with the thermal output of 28 kW, with the gas working pressure of 1.2 MPa from the distance of 20 cm for more than 45 minutes.

### EXAMPLES OF THE PERFORMANCE OF THE INVENTION

### Example 1

The thermal insulating plaster mixture contains 83 volume percent of porous glass spheres, 3 volume percent of hollow glass microspheres, 8 volume percent of aqueous solution of potassium silicate, 3.2 volume percent of aqueous solution of sodium silicate, 0.1 volume percent of water-glass-binder stabilizer, and 0.5 volume percent of styrene-acrylate dispersion.

The mixture further contains 0.8 volume percent of aqueous colloidal solution of silver in the concentration of 0.01 percent, 0.3 volume percent of an admixture of calcium stearate and sodium oleate in the ratio of 1:2, 0.3 volume percent of tensides as an aerating agent, and 0.8 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 1 to 2 mm.

The size of the hollow glass microspheres is 0.065 mm.

The molar ratio between silicon dioxide and potassium oxide in the aqueous solution of potassium silicate is within the range of 4.1, and the density of the aqueous solution is 1,250 kg/m³.

The molar ratio between silicon dioxide and sodium oxide in the aqueous solution of sodium silicate is within the range of 3.4 and the density of the aqueous solution is 1,400 kg/m³.

The resulting mixture has a doughy consistence and is to be applied with a spreader or by spraying in the layer of 2 to 4 millimetres directly on the masonry. Its appearance and properties resemble a coarse stucco plaster and it can also be used as a decorative coating.

### Example 2

The thermal insulating plaster mixture contains 88 volume percent of porous glass spheres, 2 volume percent of hollow glass microspheres, 4 volume percent of aqueous solution of potassium silicate, 1 volume percent of aqueous solution of sodium silicate, 0.1 volume percent of water-glass-binder stabilizer, and 2 volume percent of styrene-acrylate dispersion.

The mixture further contains 0.6 volume percent of aqueous colloidal solution of silver in the concentration of 0.01 percent, 0.1 volume percent of an admixture of calcium stearate and sodium oleate in the ratio of 1:2, 0.2 volume percent of tensides as an aerating agent, and 2 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 1 to 2 mm.

The size of the hollow glass microspheres is 0.065 mm.

The molar ratio between silicon dioxide and potassium oxide in the aqueous solution of potassium silicate is within the range of 3.8 and the density of the aqueous solution is 1,230 kg/m³.

The molar ratio between silicon dioxide and sodium oxide in the aqueous solution of sodium silicate is within the range of 3.2, and the density of the aqueous solution is 1,370 kg/m³.

The resulting mixture has a doughy consistence and is to be applied with a spreader or by spraying in the layer of 2 to 4 millimetres directly on the masonry. Its appearance and properties resemble a coarse stucco plaster and it can also be used as a decorative coating.

### Example 3

The thermal insulating plaster mixture contains 77 volume percent of porous glass spheres, 4 volume percent of hollow glass microspheres, 10 volume percent of aqueous solution of potassium silicate, 5 volume percent of aqueous solution of sodium silicate, 0.1 volume percent of water-glass-binder stabilizer, and 0.3 volume percent of styrene-acrylate dispersion.

The mixture further contains 1 volume percent of aqueous colloidal solution of silver in the concentration of 0.01 percent, 1.5 volume percent of an admixture of calcium stearate and sodium oleate in the ratio of 1:2, 0.6 volume percent of tensides as an aerating agent, and 0.5 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 1 to 2 mm.

The size of the hollow glass microspheres is 0.05 mm.

The molar ratio between silicon dioxide and potassium oxide in the aqueous solution of potassium silicate is within the range of 3.9 and the density of the aqueous solution is 1,240 kg/m³.

The molar ratio between silicon dioxide and sodium oxide in the aqueous solution of sodium silicate is within the range of 3.3, and the density of the aqueous solution is 1,390 kg/m³.

The resulting mixture has a doughy consistence and is to be applied with a spreader or by spraying in the layer of 2 to 4 millimetres directly on the masonry. Its appearance and properties resemble a coarse stucco plaster and it can also be used as a decorative coating.

### Example 4

The thermal insulating plaster mixture contains 79 volume percent of porous glass spheres, 2 volume percent of hollow glass microspheres, 10.8 volume percent of aqueous solution of potassium silicate, 4.4 volume percent of aqueous solution of sodium silicate, 0.1 volume percent of water-glass-binder stabilizer, and 0.8 volume percent of styrene-acrylate dispersion.

The mixture further contains 1 volume percent of aqueous colloidal solution of silver in the concentration of 0.01 percent, 0.3 volume percent of an admixture of calcium stearate and sodium oleate in the ratio of 1:2, 0.4 volume percent of tensides as an aerating agent, and 1.2 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 0.5 to 1 mm.

The size of the hollow glass microspheres is 0.08 mm.

The molar ratio between silicon dioxide and potassium oxide in the aqueous solution of potassium silicate is within the range of 4.0, and the density of the aqueous solution is 1,240 kg/m³.

The molar ratio between silicon dioxide and sodium oxide in the aqueous solution of sodium silicate is within the range of 3.3 and the density of the aqueous solution is 1,390 kg/m³.

The resulting mixture has a doughy consistence and is to be applied with a spreader or by spraying in the layer of 2 to 4 millimetres directly on the masonry. Its appearance and properties resemble a common stucco plaster.

### Example 5

The thermal insulating plaster mixture contains 83 volume percent of porous glass spheres, 1 volume percent of hollow glass microspheres, 7 volume percent of aqueous solution of potassium silicate, 2 volume percent of aqueous solution of sodium silicate, 0.1 volume percent of water-glass-binder stabilizer, and 3 volume percent of styrene-acrylate dispersion.

The mixture further contains 0.5 volume percent of aqueous colloidal solution of silver in the concentration of 0.01 percent, 0.1 volume percent of an admixture of calcium stearate and sodium oleate in the ratio of 1:2, 0.2 volume percent of tensides as an aerating agent, and 3.1 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 0.5 to 1 mm.

The size of the hollow glass microspheres is 0.065 mm.

The molar ratio between silicon dioxide and potassium oxide in the aqueous solution of potassium silicate is within the range of 3.9, and the density of the aqueous solution is 1,240 kg/m³.

The molar ratio between silicon dioxide and sodium oxide in the aqueous solution of sodium silicate is within the range of 3.3 and the density of the aqueous solution is 1,380 kg/m³.

The resulting mixture has a doughy consistence and is to be applied with a spreader or by spraying in the layer of 2 to 4 millimetres directly on the masonry. Its appearance and properties resemble a common stucco plaster.

### Example 6

The thermal insulating plaster mixture contains 75 volume percent of porous glass spheres, 3 volume percent of hollow glass microspheres, 12 volume percent of aqueous solution of potassium silicate, 6 volume percent of aqueous solution of sodium silicate, 0.1 volume percent of water-glass-binder stabilizer, and 0.3 volume percent of styrene-acrylate dispersion.

The mixture further contains 1.5 volume percent of aqueous colloidal solution of silver in the concentration of 0.01 percent, 1 volume percent of an admixture of calcium stearate and sodium oleate in the ratio of 1:2, 0.6 volume percent of tensides as an aerating agent, and 0.5 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 0.5 to 1 mm.

The size of the hollow glass microspheres is 0.065 mm.

The molar ratio between silicon dioxide and potassium oxide in the aqueous solution of potassium silicate is within the range of 4.1, and the density of the aqueous solution is 1,230 kg/m³.

The molar ratio between silicon dioxide and sodium oxide in the aqueous solution of sodium silicate is within the range of 3.2 and the density of the aqueous solution is 1,400 kg/m³.

The resulting mixture has a doughy consistence and is to be applied with a spreader or by spraying in the layer of 2 to 4 millimetres directly on the masonry. Its appearance and properties resemble a common stucco plaster.

### Example 7

The thermal insulating plaster mixture contains 83 volume percent of porous glass spheres, 1 volume percent of hollow glass microspheres, 7 volume percent of aqueous solution of potassium silicate, 2 volume percent of aqueous solution of sodium silicate, 0.1 volume percent of water-glass-binder stabilizer, and 3 volume percent of styrene-acrylate dispersion.

The mixture further contains 0.5 volume percent of aqueous colloidal solution of silver in the concentration of 0.01 percent, 0.1 volume percent of an admixture of calcium stearate and sodium oleate in the ratio of 1:2, 0.2 volume percent of tensides as an aerating agent, and 3.1 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 0.25 to 0.5 mm.

The size of the hollow glass microspheres is 0.065 mm.

The molar ratio between silicon dioxide and potassium oxide in the aqueous solution of potassium silicate is within the range of 3.9, and the density of the aqueous solution is 1,240 kg/m³.

The molar ratio between silicon dioxide and sodium oxide in the aqueous solution of sodium silicate is within the range of 3.3 and the density of the aqueous solution is 1,380 kg/m³.

The resulting mixture has a doughy consistence and is to be applied with a spreader or by spraying in the layer of 2 to 4 millimetres directly on the masonry. Its appearance and properties resemble a fine stucco plaster.

### Example 8

The thermal insulating plaster mixture contains 79 volume percent of porous glass spheres, 2 volume percent of hollow glass microspheres, 10.8 volume percent of aqueous solution of potassium silicate, 4.4 volume percent of aqueous solution of sodium silicate, 0.1 volume percent of water-glass-binder stabilizer, and 0.8 volume percent of styrene-acrylate dispersion.

The mixture further contains 1 volume percent of aqueous colloidal solution of silver in the concentration of 0.01 percent, 0.3 volume percent of an admixture of calcium stearate and sodium oleate in the ratio of 1:2, 0.4 volume percent of tensides as an aerating agent, and 1.2 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 0.25 to 0.5 mm.

The size of the hollow glass microspheres is 0.065 mm.

The molar ratio between silicon dioxide and potassium oxide in the aqueous solution of potassium silicate is within the range of 3.8, and the density of the aqueous solution is 1,240 kg/m³.

The molar ratio between silicon dioxide and sodium oxide in the aqueous solution of sodium silicate is within the range of 3.3 and the density of the aqueous solution is 1,375 kg/m³.

The resulting mixture has a doughy consistence and is to be applied with a spreader or by spraying in the layer of 2 to 4 millimetres directly on the masonry. Its appearance and properties resemble a fine stucco plaster.

### Example 9

The thermal insulating plaster mixture contains 75 volume percent of porous glass spheres, 3 volume percent of hollow glass microspheres, 12 volume percent of aqueous solution of potassium silicate, 6 volume percent of aqueous solution of sodium silicate, 0.1 volume percent of water-glass-binder stabilizer, and 0.3 volume percent of styrene-acrylate dispersion.

The mixture further contains 1.5 volume percent of aqueous colloidal solution of silver in the concentration of 0.01 percent, 1 volume percent of an admixture of calcium stearate and sodium oleate in the ratio of 1:2, 0.6 volume percent of tensides as an aerating agent, and 0.5 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the porous glass spheres ranges from 0.25 to 0.5 mm.

The size of the hollow glass microspheres is 0.065 mm.

The molar ratio between silicon dioxide and potassium oxide in the aqueous solution of potassium silicate is within the range of 3.9, and the density of the aqueous solution is 1,240 kg/m³.

The molar ratio between silicon dioxide and sodium oxide in the aqueous solution of sodium silicate is within the range of 3.3 and the density of the aqueous solution is 1,380 kg/m³.

The resulting mixture has a doughy consistence and is to be applied with a spreader or by spraying in the layer of 2 to 4 millimetres directly on the masonry. Its appearance and properties resemble a fine stucco plaster. This plaster shows a high level of water resistance, is fireproof, sanitizing and fungicidal.

### Example 10

The thermal insulating plaster mixture contains 80 volume percent of hollow glass microspheres, 9.6 volume percent of aqueous solution of potassium silicate, 0.1 volume percent of water-glass-binder stabilizer, and 2.4 volume percent of styrene-acrylate dispersion.

The mixture further contains 2 volume percent of aqueous colloidal solution of silver in the concentration of 0.01 percent, 0.8 volume percent of tensides as an aerating agent, and 5.1 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the hollow glass microspheres is 0.065 mm.

The molar ratio between silicon dioxide and potassium oxide in the aqueous solution of potassium silicate is within the range of 3.9, and the density of the aqueous solution is 1,240 kg/m³.

The resulting mixture has a pasty consistence and is to be applied with a spreader or by spraying in the layer of 1 to 2 millimetres directly on the masonry. Its appearance and properties resemble a fine gypsum plaster. The mixture is suitable for use on ceilings and under all kinds of floors.

### Example 11

The thermal insulating plaster mixture contains 78 volume percent of hollow glass microspheres, 13 volume percent of aqueous solution of potassium silicate, 0.1 volume percent of water-glass-binder stabilizer, and 1.5 volume percent of styrene-acrylate dispersion.

The mixture further contains 3 volume percent of aqueous colloidal solution of silver in the concentration of 0.01 percent, 2.4 volume percent of tensides as an aerating agent, and 2 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the hollow glass microspheres is 0.065 mm.

The molar ratio between silicon dioxide and potassium oxide in the aqueous solution of potassium silicate is within the range of 3.8, and the density of the aqueous solution is 1,240 kg/m³.

The resulting mixture has a pasty consistence and is to be applied with a spreader or by spraying in the layer of 1 to 2 millimetres directly on the masonry. Its appearance and properties resemble a fine gypsum plaster. The mixture is suitable for use on ceilings and under all kinds of floors.

### Example 12

The thermal insulating plaster mixture contains 82 volume percent of hollow glass microspheres, 5 volume percent of aqueous solution of potassium silicate, 0.1 volume percent of water-glass-binder stabilizer, and 5 volume percent of styrene-acrylate dispersion.

The mixture further contains 0.4 volume percent of aqueous colloidal solution of silver in the concentration of 0.01 percent, 0.5 volume percent of tensides as an aerating agent, and 7 volume percent of water.

Hydrophilic alkoxyle alkyl ammonia salts in the form of 98-percent aqueous solution of N,N,N′,N′-Tetrakis (2-hydroxypropyl) ethylene diamine are used as a water-glass-binder stabilizer.

The size of the hollow glass microspheres is 0.065 mm.

The molar ratio between silicon dioxide and potassium oxide in the aqueous solution of potassium silicate is within the range from 3.8 to 4.1 and the density of the aqueous solution ranges from 1230 to 1250 kg/m³.

The resulting mixture has a pasty consistence and is to be applied with a spreader or by spraying in the layer of 1 to 2 millimetres directly on the masonry. Its appearance and properties resemble a fine gypsum plaster. The mixture is suitable for use on ceilings and under all kinds of floors.

### INDUSTRIAL APPLICATION

The thermal insulating plaster mixture according to this invention can especially be used as a thin-layered thermal insulation for masonry, plasters, wood and for oriented strand boards (OSB), for gypsum plasterboards as well as for metal, glass and other surfaces.

1. A thermal insulating plaster mixture, comprising an aqueous solution of silicate comprising 78 to 90 volume percent of hollow glass microspheres, 5 to 17 volume percent of aqueous solution of potassium silicate, 0.1 volume percent of water-glass-binder stabilizer, 1.5 to 5 volume percent of styrene-acrylate dispersion, 0.4 to 3 volume percent of aqueous colloidal solution of silver, 0.2 to 2.4 volume percent of tensides as an aerating agent, and 0.5 to 7 volume percent of water.

2. A thermal insulating plaster mixture which comprises an aqueous solution of silicate, comprising 75 to 90 volume percent of porous glass spheres, 1 to 4 volume percent of hollow glass microspheres, 4 to 14 volume percent of aqueous solution of potassium silicate, 1 to 6 volume percent of aqueous solution of sodium silicate, 0.1 volume percent of water-glass-binder stabilizer, 0.3 to 3 volume percent of styrene-acrylate dispersion, 0.4 to 3 volume percent of aqueous colloidal solution of silver, 0.2 to 2.4 volume percent of tensides as an aerating agent, 0.5 to 7 volume percent of water, and 0.1 to 1.5 volume percent of an admixture of calcium stearate and sodium oleate in the ratio of 1:2.

3. The thermal insulating plaster mixture according to claim 1, wherein the mixture further comprises hydrophilic alkoxyle alkyl ammonia salts as a water-glass-binder stabilizer.

4. The thermal insulating plaster mixture according to claim 2, wherein the size of the porous glass spheres is within the range from 0.25 to 2 mm.

5. The thermal insulating plaster mixture according to claim 1, wherein the size of the hollow glass microspheres is within the range of 0.05 to 0.08 mm.

6. The thermal insulating plaster mixture according to claim 1, wherein the concentration of the aqueous colloidal solution of silver is 0.01 percent.

7. The thermal insulating plaster mixture according to claim 1, wherein the molar ratio between silicon dioxide and potassium oxide in the aqueous solution of potassium silicate is within the range of 3.8 to 4.1.

8. The thermal insulating plaster mixture according to claim 1, wherein the density of the aqueous solution of potassium silicate is 1,230 to 1,250 kg/m³.

9. The thermal insulating plaster mixture according to claim 2, wherein the molar ratio between silicon dioxide and sodium oxide in the aqueous solution of sodium silicate is within the range of 3.2 to 3.4.

10. The thermal insulating plaster mixture according to claim 2, wherein the density of the aqueous solution of sodium silicate is 1,370 to 1,400 kg/m³.
